(19) United States
(12) Patent Application Publication
(10) Pub. No.: US 2024/0280803 A1
(43) Pub. Date: Aug. 22, 2024

(54) OPTICAL MODULE AND OPTICAL DEVICE

(71) Applicant: Murata Manufacturing Co., Ltd., Nagaokakyo-shi (JP)

(72) Inventors: Yuuki ISHII, Nagaokakyo-shi (JP); Yuka TANAKA, Nagaokakyo-shi (JP); Katsuhiro TABUCHI, Nagaokakyo-shi (JP); Takahide NAKADOI, Nagaokakyo-shi (JP); Noritaka KISHI, Nagaokakyo-shi (JP); Hitoshi SAKAGUCHI, Nagaokakyo-shi (JP)

(21) Appl. No.: 18/652,018

(22) Filed: May 1, 2024

Related U.S. Application Data
(63) Continuation of application No. PCT/JP2022/024333, filed on Jun. 17, 2022.

(30) Foreign Application Priority Data
Nov. 30, 2021 (JP) 2021-194449

(51) Int. Cl. G02B 27/00; B06B 1/06; B08B 7/02

(52) U.S. Cl. CPC G02B 27/0006; B06B 1/06; B08B 7/026

(57) ABSTRACT

An optical module includes a translucent portion, a tubular vibrator supporting the translucent portion, a piezoelectric element at the vibrator to vibrate the vibrator, and an inner-layer optical component at an inner side portion of the vibrator. A recess recessed in a thickness direction of the translucent portion and includes a curvature at a surface of the translucent portion facing the inner-layer optical component, the inner-layer optical component includes an inner-layer lens that faces the translucent portion and includes a first portion that protrudes toward the translucent portion and includes a curvature and a second portion at an outer periphery of the first portion, a first gap is located between the first portion and the translucent portion in the outer periphery of the first portion, a second gap is located between the second portion and the translucent portion, and the second gap is larger than the first gap.

### CROSS REFERENCE TO RELATED APPLICATIONS

This application claims the benefit of priority to Japanese Patent Application No. 2021-194449 filed on Nov. 30, 2021 and is a Continuation Application of PCT Application No. PCT/JP2022/024333 filed on Jun. 17, 2022. The entire contents of each application are hereby incorporated herein by reference.

### BACKGROUND OF THE INVENTION

### 1. Field of the Invention

The present invention relates to optical modules and optical devices that each are capable of removing a liquid droplet or the like by vibration.

### 2. Description of the Related Art

Japanese Unexamined Patent Application Publication No. 2017-170303 discloses a liquid droplet exclusion device including a vibration generation member that is connected to an end portion of a curved surface that forms a dome portion of an optical element, the vibration generation member generating a bending vibration in the dome portion. In the liquid droplet exclusion device disclosed in Japanese Unexamined Patent Application Publication No. 2017-170303, a drip-resistant cover and a piezoelectric element are adhesively fixed to each other, and the drip-resistant cover is caused to bend and vibrate by the vibration of the piezoelectric element, thereby removing liquid droplets and the like adhering to the surface of the drip-resistant cover.

### SUMMARY OF THE INVENTION

In the device disclosed in Japanese Unexamined Patent Application Publication No. 2017-170303, there is still room for improvement in terms of reducing or preventing the vibration attenuation.

According to an example embodiment of the present invention, an optical module includes a translucent portion, a vibrator that is tubular and supports the translucent portion, a piezoelectric element located at the vibrator to vibrate the vibrator, and an inner-layer optical component located at an inner side portion of the vibrator. A recess that is recessed in a thickness direction of the translucent portion and includes a curvature at a surface of the translucent portion facing the inner-layer optical component. The inner-layer optical component includes an inner-layer lens that faces the translucent portion and includes a first portion that protrudes toward the translucent portion and includes a curvature and a second portion that is provided at an outer periphery of the first portion, a first gap is located between the first portion and the translucent portion in the outer periphery of the first portion, a second gap is located between the second portion and the translucent portion, and the second gap is larger than the first gap.

According to another example embodiment of the present invention, an optical device includes the optical module according to the above example embodiment, and an optical element located at the optical module.

Example embodiments of the present invention provide optical modules and optical devices each capable of reducing or preventing vibration attenuation.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view showing an example of an optical device in Example Embodiment 1 according to the present invention.

FIG. 2 is a schematic cross-sectional view showing an example of a configuration of the optical device in Example Embodiment 1 according to the present invention.

FIG. 3 is a block diagram showing an example of a functional configuration of the optical device in Example Embodiment 1 according to the present invention.

FIGS. 4A and 4B are schematic views for describing a gap between a translucent portion and an inner-layer lens.

FIG. 5 is a schematic view for describing Comparative Example 1, Comparative Example 2, and Example 1.

FIG. 6 is a graph showing an example of a simulation result of a displacement amount and acoustic pressure of the translucent portion in Comparative Example 1, Comparative Example 2, and Example 1.

FIG. 7 is a view showing an example of a displacement distribution and an acoustic pressure distribution in Comparative Example 1, Comparative Example 2, and Example 1.

FIG. 8 is a graph showing an example of a relationship between a dimension of a second gap and a displacement amount of the translucent portion.

FIG. 9 is a graph showing an example of a relationship between a curvature of a recess of the translucent portion and a curvature of a first portion of the inner-layer lens.

FIG. 10 is a schematic cross-sectional view showing a main configuration of an optical module in Modification Example 1.

FIG. 11 is a schematic cross-sectional view showing a main configuration of an optical module in Modification Example 2.

FIG. 12 is a schematic cross-sectional view showing a main configuration of an optical device in Modification Example 3.

### DETAILED DESCRIPTION OF THE EXAMPLE EMBODIMENTS

In a vehicle provided with an imaging unit including an imaging element or the like in a front portion or a rear portion of the vehicle, an image acquired by the imaging unit is used to control a safety device or perform automatic driving control. Such an imaging unit is disposed outside the vehicle in some cases. In this case, a translucent portion such as a protective cover or a lens is disposed at an exterior of the imaging unit.

Therefore, foreign matters such as raindrops (liquid droplets), mud, and dust may adhere to the translucent portion. In a case where a foreign matter adheres to the translucent portion, in some cases, the foreign matter is reflected in an image acquired by the imaging unit, and it is not possible to obtain a clear image.

In recent years, a device that removes a foreign matter adhering to a translucent portion by vibrating the translucent portion has been developed. In such a device, the translucent portion is disposed at a tubular vibrator, and the translucent portion is vibrated by vibrating the vibrator with a piezoelectric element or the like. An inner-layer optical component such as an inner-layer lens is disposed inside the vibrator.

However, in some cases, the vibration of the translucent portion and/or the vibrator is attenuated depending on the position of the inner-layer optical component disposed inside the vibrator. For example, a gap is provided between the translucent portion and the inner-layer optical component, and the vibration attenuation occurs depending on the dimension of the gap. As a result, there is a problem that it is not possible to sufficiently remove the foreign matter adhering to the translucent portion. This is a new problem discovered by the inventors of example embodiments of the present invention.

For example, in a case where the translucent portion is vibrated, an acoustic wave is generated by the vibration. The acoustic wave generated from the translucent portion is reflected by the inner-layer optical component, and a standing wave including an antinode and a node of the acoustic wave is generated. In the antinode of the acoustic wave, the acoustic pressure is increased as compared with other portions, and the air is further compressed. Therefore, in the antinode of the acoustic wave, the compressed air acts as a damper, and the vibration attenuation occurs. Thus, in a case where the antinode of the acoustic wave is formed at a position at which the translucent portion is disposed in the gap between the translucent portion and the inner-layer optical component, the vibration of the translucent portion is attenuated. As a result, in some cases, it is not possible to sufficiently remove the foreign matter adhering to the translucent portion.

In order to dispose the inner-layer optical component to avoid the antinode and the node generated by the reflection of the acoustic wave generated from the translucent portion, it is considered that the inner-layer optical component is disposed close to the translucent portion, and a gap between the translucent portion and the inner-layer optical component is reduced. In this case, the volume of the air in the gap is reduced and the acoustic pressure is increased, regardless of the presence or absence of the standing wave. As a result, the vibration attenuation occurs in some cases.

The present inventors have conducted intensive studies, and discovered and conceived of a configuration in which the attenuation of the vibration is reduced or prevented by reducing or preventing an increase in acoustic pressure in the gap between the translucent portion and the inner-layer optical component, which led to development of example embodiments of the present invention.

According to a first example embodiment of the present invention, an optical module includes a translucent portion, a vibrator that is tubular and supports the translucent portion, a piezoelectric element located at the vibrator to vibrate the vibrator, and an inner-layer optical component at an inner side portion of the vibrator. A recess that is recessed in a thickness direction of the translucent portion and includes a curvature at a surface of the translucent portion facing the inner-layer optical component, the inner-layer optical component includes an inner-layer lens that faces the translucent portion, the inner-layer lens includes a first portion that protrudes toward the translucent portion and includes a curvature and a second portion that is provided at an outer periphery of the first portion, a first gap is located between the first portion and the translucent portion in the outer periphery of the first portion, a second gap is located between the second portion and the translucent portion, and the second gap is larger than the first gap.

With such a configuration, it is possible to reduce or prevent the vibration attenuation.

The second portion may include a step that is recessed in a direction separated farther from the translucent portion than the first portion.

With such a configuration, it is possible to further reduce or prevent the vibration attenuation.

The second portion may include an inclination surface that is inclined in a direction extending away from the translucent portion toward an outer periphery of the inner-layer lens.

With such a configuration, it is possible to further reduce or prevent the vibration attenuation.

A size of the second gap may be about 1.2 times or more that of the first gap.

With such a configuration, it is possible to further reduce or prevent the vibration attenuation.

When viewed from the thickness direction of the translucent portion, an outer diameter of the inner-layer lens may be larger than an outer diameter of the recess of the translucent portion.

With such a configuration, it is possible to reduce or prevent the vibration attenuation while maintaining the optical characteristics of the inner-layer lens.

The curvature of the first portion of the inner-layer lens may be larger than the curvature of the recess of the translucent portion.

With such a configuration, it is possible to further reduce or prevent the vibration attenuation.

The second portion may include a flat surface perpendicular to a thickness direction of the inner-layer lens, the inner-layer optical component may include a lens holding portion that has a tubular shape and accommodates the inner-layer lens, and the lens holding portion may include a pressing portion that is in contact with the flat surface at an inner side portion of the lens holding portion.

With such a configuration, it is possible to hold the optical characteristics of the inner-layer lens while maintaining the optical characteristics.

The first portion may be located in the recess of the translucent portion.

With such a configuration, it is possible to reduce or prevent the vibration attenuation while reducing the size of the module.

The inner-layer lens may be a spherical lens or an aspherical lens.

With such a configuration, it is possible to further reduce or prevent the vibration attenuation.

The recess of the translucent portion may be recessed in a hemispherical or substantially hemispherical shape.

With such a configuration, it is possible to further reduce or prevent the vibration attenuation.

According to an example embodiment of the present disclosure, an optical device includes the optical module according to the above example embodiment, and an optical element at the optical module.

With such a configuration, it is possible to reduce or prevent the vibration attenuation.

Hereinafter, example embodiments of the present invention will be described with reference to the accompanying drawings. The following description merely describes examples in essence, and is not intended to limit the present disclosure or an application of example embodiments of the present disclosure is applied. Further, the drawings are schematic, and the proportions of the respective dimensions and the like do not necessarily match the actual proportions.

### Example Embodiment 1

### Optical Device

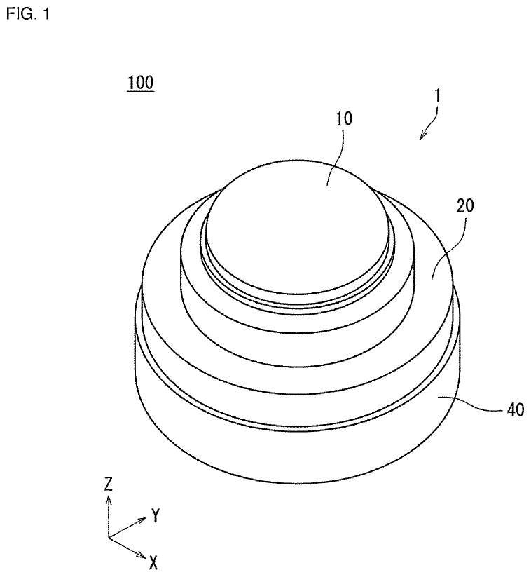

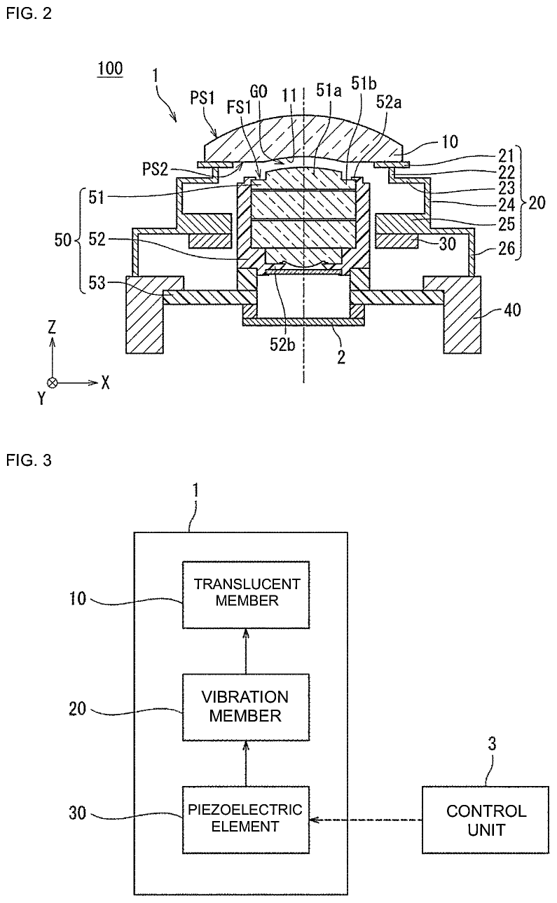

FIG. 1 is a schematic perspective view showing an example of an optical device 100 in Example Embodiment 1 according to the present invention. FIG. 2 is a schematic cross-sectional view showing an example of a configuration of the optical device 100 in Example Embodiment 1 according to the present invention. The X, Y, and Z-directions in the drawings indicate a longitudinal direction, a lateral direction, and a height direction of the optical device 100.

As shown in FIGS. 1 and 2, the optical device 100 includes an optical module 1 and an optical element 2. The optical element 2 is disposed at the optical module 1. Specifically, the optical element 2 is disposed inside the optical module 1.

In the present example embodiment, an example in which the optical device 100 is an imaging device will be described.

The optical device 100 is attached to, for example, a front or rear of a vehicle and images an imaging target. The place where the optical device 100 is attached is not limited to the vehicle, and the optical device 100 may be attached to another device such as a ship or an aircraft.

The optical element 2 is an imaging element, and is, for example, a CMOS, a CCD, a bolometer, or a thermopile that receives light having a wavelength in any of the visible region or the far infrared region.

In a case where the optical device 100 is attached to a vehicle or the like and is used outdoors, foreign matters such as raindrops, mud, and dust may adhere to a translucent portion 10 of the optical module 1 that is disposed in a viewing field direction of the optical element 2 and covers the outside. The optical module 1 can generate vibration in order to remove foreign matters such as raindrops adhering to the translucent portion 10.

### Optical Module

As shown in FIGS. 1 and 2, the optical module 1 includes a translucent portion 10, a vibrator 20, a piezoelectric element 30, a fixing portion 40, and an inner-layer optical component 50. The fixing portion 40 is not an essential configuration in the optical module 1.

### Translucent Portion

The translucent portion 10 has translucency in which energy rays or light having a wavelength to be detected by the optical element 2 is transmitted through the translucent portion 10. In the present example embodiment, the translucent portion 10 is a cover for protecting the optical element 2 and the inner-layer optical component 50 from adhering of foreign matters. In the optical device 100, the optical element 2 detects the energy ray or the light through the translucent portion 10.

As a material for forming the translucent portion 10, for example, translucent plastic, glass such as quartz and borosilicate, translucent ceramics, synthetic resin, or the like can be used. The strength of the translucent portion 10 can be increased, for example, by forming the translucent portion 10 with tempered glass. In the present example embodiment, the translucent portion 10 is formed of BK-7 (borosilicate glass).

The translucent portion 10 has, for example, a dome shape. The translucent portion 10 may have a circular shape when viewed from a height direction (Z-direction) of the optical module 1. The shape of the translucent portion 10 is not limited thereto.

In the present example embodiment, the translucent portion 10 includes a first main surface PS1 and a second main surface PS2 on an opposite side of the first main surface PS1. The first main surface PS1 is a main surface located at the outer side portion of the translucent portion 10. The first main surface PS1 is a continuous curved surface. Specifically, the first main surface PS1 is curved roundly. The second main surface PS2 is a main surface located at the inner side portion of the translucent portion 10. A recess 11 is provided on a flat surface of the second main surface PS2.

Specifically, the second main surface PS2 is a surface that faces the inner-layer optical component 50 in the translucent portion 10. The recess 11 that is recessed in the thickness direction (Z-direction) of the translucent portion 10 and includes a curvature is provided at the second main surface PS2. For example, the recess 11 is provided at the center of the translucent portion 10 when viewed from the thickness direction (Z-direction) of the translucent portion 10, and has a circular shape. For example, the recess 11 has a shape that is recessed in a hemispherical shape.

An outer peripheral end portion of the translucent portion 10 is bonded to the vibrator 20. Specifically, the second main surface PS2 of the translucent portion 10 and a vibration flange 21 of the vibrator 20 are bonded to each other along an outer periphery of the translucent portion 10 when viewed from the thickness direction (Z-direction) of the translucent portion 10. The translucent portion 10 and the vibrator 20 can be bonded to each other using, for example, an adhesive or a brazing material. Alternatively, thermal pressure bonding, anodic bonding, or the like can be used.

### Vibrator

The vibrator 20 preferably has a tubular shape and supports the translucent portion 10. The vibrator 20 vibrates the translucent portion 10 by being vibrated by the piezoelectric element 30.

The vibrator 20 includes the vibration flange 21, a first tubular member 22, a spring portion 23, a second tubular member 24, a vibration plate 25, and a connection portion 26. The connection portion 26 is not an essential configuration in the vibrator 20.

The vibration flange 21 includes an annular plate member when viewed in the height direction (Z-direction) of the optical module 1. The vibration flange 21 is disposed along the outer periphery of the translucent portion 10 and is bonded to the translucent portion 10. The vibration flange 21 stably supports the translucent portion 10 by being in surface contact with the translucent portion 10.

The first tubular member 22 preferably has a tubular shape having one end and the other end. The first tubular member 22 is formed by a hollow member in which a through-hole is provided. The through-hole is provided in the height direction (Z-direction) of the optical module 1, and openings of the through-hole are provided at the one end and the other end of the first tubular member 22. The first tubular member 22 has, for example, a cylindrical shape. The outer shape of the first tubular member 22 and the opening of the through-hole are formed in a circular shape when viewed from the height direction of the optical module 1.

The vibration flange 21 is provided at the one end of the first tubular member 22, and the spring portion 23 is provided at the other end of the first tubular member 22. The first tubular member 22 is supported by the spring portion 23 while supporting the vibration flange 21.

The spring portion 23 includes a leaf spring that supports the other end of the first tubular member 22. The spring portion 23 is configured to be elastically deformed. The spring portion 23 supports the other end of the first tubular member 22 having a cylindrical shape and extends toward the outer side portion of the first tubular member 22 from a position at which the spring portion 23 supports the other end of the first tubular member 22.

The spring portion 23 preferably has a plate shape. The spring portion 23 has a hollow circular shape in which a through-hole is provided, and extends to surround the periphery of the first tubular member 22 in a circular shape. In other words, the spring portion 23 has an annular plate shape. The annular plate shape means a shape in which a plate preferably has a ring shape. The outer shape of the spring portion 23 and an opening of the through-hole preferably have a circular shape when viewed from the height direction (Z-direction) of the optical module 1.

The spring portion 23 connects the first tubular member 22 and the second tubular member 24. Specifically, the spring portion 23 is connected to the first tubular member 22 on an inner peripheral side of the spring portion 23 and is connected to the second tubular member 24 on an outer peripheral side of the spring portion 23.

The second tubular member 24 preferably has a tubular shape having one end and the other end. The second tubular member 24 is located at the outer side portion of the first tubular member 22 when viewed from the height direction (Z-direction) of the optical module 1, and supports the spring portion 23. The spring portion 23 is connected to the one end of the second tubular member 24. The vibration plate 25 is connected to the other end of the second tubular member 24.

The second tubular member 24 is formed by a hollow member in which a through-hole is provided. The through-hole is provided in the height direction (Z-direction) of the optical module 1, and openings of the through-hole are provided at the one end and the other end of the second tubular member 24. The second tubular member 24 has, for example, a cylindrical shape. The outer shape of the second tubular member 24 and the opening of the through-hole are formed in a circular shape when viewed from the height direction of the optical module 1.

The vibration plate 25 is a plate-shaped member that extends from the other end of the second tubular member 24 toward the inner side portion. The vibration plate 25 supports the other end of the second tubular member 24 and extends toward the inner side portion of the second tubular member 24 from a position at which the vibration plate 25 supports the other end of the second tubular member 24.

The vibration plate 25 has a hollow circular shape in which a through-hole is provided, and is provided along an inner periphery of the second tubular member 24. The vibration plate 25 has an annular plate shape.

The connection portion 26 connects the vibration plate 25 and the fixing portion 40 to each other. The connection portion 26 extends toward the outer side portion from the outer peripheral end portion of the vibration plate 25 and is bent toward the fixing portion 40. The connection portion 26 is supported by the fixing portion 40. The connection portion 26 is configured to have a node, and thus the vibration from the vibration plate 25 is less likely to be transmitted.

In the present example embodiment, the first tubular member 22, the spring portion 23, the second tubular member 24, the vibration plate 25, and the connection portion 26 are integrally formed. The first tubular member 22, the spring portion 23, the second tubular member 24, the vibration plate 25, and the connection portion 26 may be formed separately or may be formed by separate members.

The elements included in the above-described vibrator 20 may be made of, for example, metal or ceramics. As the metal, for example, stainless steel, 42 alloy, 50 alloy, Invar, super Invar, cobalt, aluminum, duralumin, or the like can be used. Alternatively, the elements of the vibrator 20 may be made of ceramics such as alumina and zirconia, or may be made of a semiconductor such as Si. Further, the elements of the vibrator 20 may be covered with an insulating material. The elements of the vibrator 20 may be subjected to a black body treatment.

The shapes and the dispositions of the elements of the vibrator 20 are not limited to the examples described above.

### Piezoelectric Element

The piezoelectric element 30 is disposed at the vibrator 20 and vibrates the vibrator 20. The piezoelectric element 30 is provided on the main surface of the vibration plate 25. Specifically, the piezoelectric element 30 is provided on a main surface of the vibration plate 25 on an opposite side of a side where the translucent portion 10 is located. The piezoelectric element 30 vibrates the second tubular member 24 in a penetration direction (Z-direction) by vibrating the vibration plate 25. For example, the piezoelectric element 30 vibrates when a voltage is applied.

The piezoelectric element 30 has a hollow circular shape in which a through-hole is provided. In other words, the piezoelectric element 30 has an annular plate shape. The outer shape of the piezoelectric element 30 and an opening of the through-hole are formed in a circular shape when viewed from the height direction (Z-direction) of the optical module 1.

The outer shape of the piezoelectric element 30 and the opening of the through-hole are not limited thereto.

The piezoelectric element 30 includes a piezoelectric body and an electrode. As a material for forming the piezoelectric body, for example, appropriate piezoelectric ceramics such as barium titanate (BaTiO₃), lead zirconate titanate (PZT: PbTiO₃·PbZrO₃), lead titanate (PbTiO₃), lead metaniobate (PbNb₂O₆), bismuth titanate (Bi₄Ti₃O₁₂), and (K,Na)NbO₃, or appropriate piezoelectric single crystals such as LiTaO₃ and LiNbO₃ can be used. The electrode may be, for example, a Ni electrode. The electrode may be an electrode formed with a metal thin film of Ag, Au, or the like, which is formed by a sputtering method. Alternatively, the electrode can be formed by plating or vapor deposition in addition to sputtering.

The fixing portion 40 fixes the vibrator 20. The fixing portion 40 also fixes the inner-layer optical component 50. The fixing portion 40 preferably has a tubular shape. For example, the fixing portion 40 has a cylindrical shape. The shape of the fixing portion 40 is not limited to the cylindrical shape. The fixing portion 40 may be formed integrally with the vibrator 20.

### Inner-Layer Optical Component

As shown in FIG. 2, the inner-layer optical component 50 is an optical component disposed inside the vibrator 20. For example, the inner-layer optical component 50 is a lens module.

In the present example embodiment, the inner-layer optical component 50 includes an inner-layer lens 51, a lens holding portion 52, and an inner-layer flange 53.

The inner-layer lens 51 may include a plurality of lenses. The inner-layer lens 51 is disposed on an optical path of the optical element 2 at the inner side portion of the vibrator 20 and faces the translucent portion 10. The inner-layer lens 51 includes a first portion 51a and a second portion 51b on a side facing the translucent portion 10. Specifically, among the plurality of lenses constituting the inner-layer lens 51, the lens disposed at a position facing the translucent portion 10 includes the first portion 51a and the second portion 51b.

The first portion 51a is a portion that protrudes toward the translucent portion 10 and includes a curvature in the inner-layer lens 51. The first portion 51a has a circular shape when viewed from the thickness direction (Z-direction) of the inner-layer lens 51. The first portion 51a has a shape in which a thickness increases toward the center of the inner-layer lens 51. For example, the first portion 51a has a spherical shape. The first portion 51a includes an outer wall that extends in the thickness direction (Z-direction) of the inner-layer lens 51. The first portion 51a is connected to the second portion 51b at the lower end of the outer wall.

The second portion 51b is a portion that is provided at an outer periphery of the first portion 51a in the inner-layer lens 51. The second portion 51b preferably has a ring shape when viewed from the thickness direction (Z-direction) of the inner-layer lens 51.

In the present example embodiment, the second portion 51b is a step that is recessed in a direction separated farther from the translucent portion 10 than the first portion 51a in the thickness direction (Z-direction) of the inner-layer lens 51. The second portion 51b includes a flat surface FS1 at a position separated farther from the translucent portion 10 than the first portion 51a in the thickness direction (Z-direction) of the inner-layer lens 51. The flat surface FS1 is perpendicular to the thickness direction (Z-direction) of the inner-layer lens 51. That is, the flat surface FS1 extends in the X, Y-directions.

The inner-layer lens 51 is configured by, for example, a spherical lens. The inner-layer lens 51 is not limited to the spherical lens, and may be configured by an aspherical lens.

The lens holding portion 52 holds the inner-layer lens 51. The lens holding portion 52 preferably has a tubular shape having one end and the other end. Specifically, the lens holding portion 52 has a cylindrical shape and holds an outer periphery of the inner-layer lens 51.

The lens holding portion 52 includes a pressing portion 52a that is in contact with the flat surface FS1 of the second portion 51b at an inner side portion of the lens holding portion 52. The pressing portion 52a is a member that protrudes toward the inner side portion of the lens holding portion 52 at one end of the lens holding portion 52. The pressing portion 52a preferably has a ring shape when viewed from a height direction (Z-direction) of the inner-layer optical component 50. The pressing portion 52a is in contact with the flat surface FS1 of the second portion 51b and presses the flat surface FS1 in the thickness direction (Z-direction) of the inner-layer lens 51.

In the present example embodiment, a contact portion 52b that is in contact with the inner-layer lens 51 is provided at the other end of the lens holding portion 52. The contact portion 52b protrudes toward the inner side portion of the lens holding portion 52 on the other end side of the lens holding portion 52. For example, the contact portion 52b preferably has a ring shape when viewed from the height direction (Z-direction) of the inner-layer optical component 50. The inner-layer lens 51 is accommodated in the lens holding portion 52 and is pressed against the contact portion 52b by the pressing portion 52a. As a result, the inner-layer lens 51 is held in the lens holding portion 52. The contact portion 52b may be attachable to and detachable from the lens holding portion 52. For example, the contact portion 52b may have an annular shape and may be attached to the lens holding portion 52 by a screw structure.

The inner-layer flange 53 extends toward an outer side portion from an outer wall of the lens holding portion 52. Specifically, the inner-layer flange 53 is connected to the other end of the lens holding portion 52 and extends toward the fixing portion 40. The inner-layer flange 53 preferably has an annular plate shape when viewed from the height direction (Z-direction) of the optical module 1. An outer periphery of the inner-layer flange 53 is connected to the fixing portion 40. The inner-layer flange 53 is fixed to the inner side portion of the vibrator 20 by being supported by the fixing portion 40.

FIG. 3 is a block diagram showing an example of a functional configuration of the optical device 100 in Example Embodiment 1 according to the present invention. As shown in FIG. 3, the piezoelectric element 30 is controlled by a control unit 3. The control unit 3 is configured or programmed to apply a drive signal to generate the vibration to the piezoelectric element 30. The control unit 3 is connected to the piezoelectric element 30, for example, with a power supply conductor interposed therebetween. The piezoelectric element 30 vibrates in the height direction (Z-direction) of the optical module 1 based on the drive signal from the control unit 3. The piezoelectric element 30 is vibrated to vibrate the vibrator 20, and the vibration of the vibrator 20 is transmitted to the translucent portion 10 to vibrate the translucent portion 10. As a result, foreign matters such as raindrops adhering to the translucent portion 10 are removed.

The control unit 3 can be realized by, for example, a semiconductor element or the like. For example, the control unit 3 can be configured by a microcomputer, a central processing unit (CPU), a micro processing unit (MPU), a graphics processing unit (GPU), a digital signal processor (DSP), a field programmable gate array (FPGA), or an application specific integrated circuit (ASIC). The function of the control unit 3 may be realized by only hardware or by a combination of hardware and software.

For example, the control unit 3 realizes a predetermined function by reading data or a program stored in a storage unit and performing various types of arithmetic processing.

The control unit 3 may be provided in the optical device 100, or may be provided in a control device different from the optical device 100. For example, in a case where the optical device 100 does not include the control unit 3, the optical device 100 may be controlled by a control device including the control unit 3. Alternatively, the optical module 1 may include the control unit 3.

### Regarding A Gap

Next, a gap located between the translucent portion 10 and the inner-layer lens 51 in the optical module 1 will be described.

Returning to FIG. 2, a gap G0 is located between the translucent portion 10 and the inner-layer lens 51.

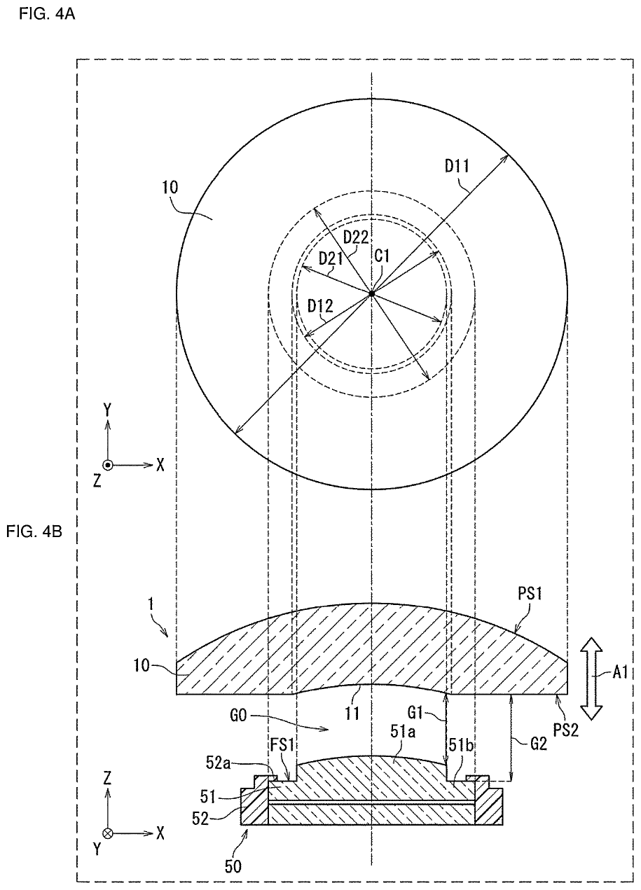

FIGS. 4A and 4B are schematic views for describing the gap G0 between the translucent portion 10 and the inner-layer lens 51. FIG. 4A shows a schematic view of the translucent portion 10 when viewed from the first main surface PS1 side. FIG. 4B shows a schematic cross-sectional view of the vicinity of the translucent portion 10. In FIGS. 4A and 4B, the reference sign D11 indicates an outer diameter of the translucent portion 10, the reference sign D12 indicates an outer diameter of the recess 11 of the translucent portion 10, the reference sign D21 indicates an outer diameter of the first portion 51a of the inner-layer lens 51, and the reference sign D22 indicates an outer diameter of the second portion 51b of the inner-layer lens 51. The reference sign A1 indicates a vibration direction of the translucent portion 10.

The outer diameter D12 of the recess 11 means a diameter that defines the recess 11 on the second main surface PS2 of the translucent portion 10. The outer diameter D22 of the second portion 51b of the inner-layer lens 51 also means the outer diameter of the inner-layer lens 51. The reference signs D11, D12, D21, and D22 are dimensions when viewed from the height direction (Z-direction) of the optical module 1.

In the present example embodiment, when viewed from the height direction (Z direction) of the optical module 1, the outer diameter D12 of the recess 11 is larger than the outer diameter D11 of the first portion 51a of the inner-layer lens 51. The outer diameter D22 of the inner-layer lens 51 is larger than the outer diameter D12 of the recess 11. As a result, it is possible to improve the optical characteristics. By making the outer diameter D22 of the inner-layer lens 51 larger than the outer diameter D12 of the recess 11, light incident from the translucent portion 10 is easily incident to the optical element 2 through the inner-layer lens 51.

As shown in FIGS. 4A and 4B, the gap G0 is formed between the translucent portion 10 and the inner-layer lens 51. Specifically, the gap G0 is located between the second main surface PS2 of the translucent portion 10 and the surface of the inner-layer lens 51 facing the second main surface PS2 of the translucent portion 10.

In the gap G0, a first gap G1 and a second gap G2 are located. The first gap G1 is located between the first portion 51a and the translucent portion 10 at the outer periphery of the first portion 51a of the inner-layer lens 51. For example, the first gap G1 is located between the first portion 51a and the recess 11 at the outer periphery of the first portion 51a. The second gap G2 is located between the second portion 51b of the inner-layer lens 51 and the translucent portion 10. For example, the second gap G2 is located between the flat surface FS1 of the second portion 51b and the second main surface PS2 of the translucent portion 10.

The second gap G2 is larger than the first gap G1. Specifically, in the height direction (Z-direction) of the optical module 1, the dimension of the second gap G2 is larger than the dimension of the first gap G1. By making the dimension of the second gap G2 larger than the dimension of the first gap G1, it is possible to reduce or prevent reduction in the volume of the air in the gap G0. As a result, it is possible to reduce or prevent an increase in acoustic pressure and reduce or prevent the vibration attenuation, in the gap G0.

In the present example embodiment, the pressing portion 52a is disposed at the second portion 51b, but even in a case where the second gap G2 is reduced by the thickness of the pressing portion 52a, the second gap G2 is larger than the first gap G1.

### Regarding Relationship Between Displacement Amount of Translucent Portion and Acoustic Pressure

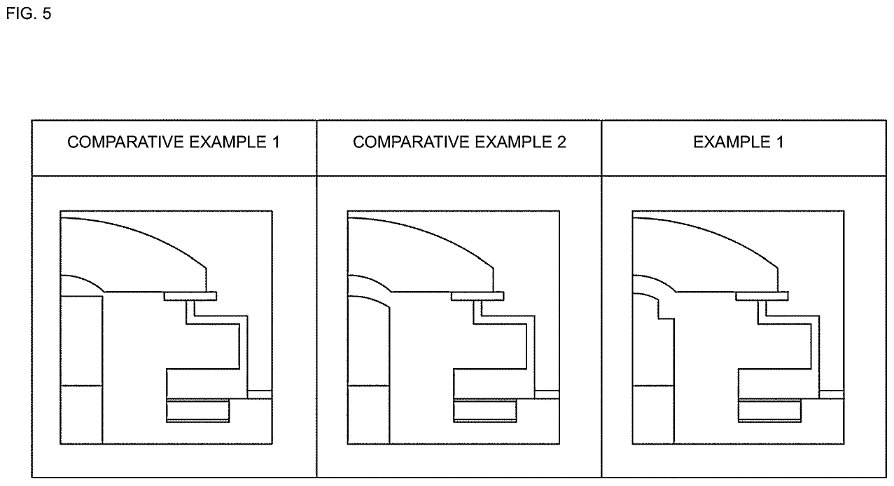

In order to examine a relationship between the displacement amount of the translucent portion 10 and the acoustic pressure, simulations were performed using analysis models of Comparative Example 1, Comparative Example 2, and Example 1. The analysis models and the simulation results of Comparative Example 1, Comparative Example 2, and Example 1 will be described with reference to FIGS. 5 to 7. The piezoelectric/acoustic wave analysis (harmonic analysis, strong coupling) was performed by simulation using Femtet manufactured by Murata Software Co., Ltd. In the analysis models, a material of the translucent portion 10 was borosilicate glass, a material for forming the vibrator 20 was stainless, and the piezoelectric element 30 was PZT. The translucent portion 10 and the vibrator 20 were bonded to each other with epoxy resin. The resonant frequency of the vibrator 20 was set to about 27 kHz, for example.

FIG. 5 is a schematic view for describing Comparative Example 1, Comparative Example 2, and Example 1. As shown in FIG. 5, in Comparative Example 1, an analysis model having an inner-layer lens in which a surface facing the translucent portion is a flat surface is used. In Comparative Example 2, an analysis model having an inner-layer lens that includes a curvature and in which a surface facing the translucent portion protrudes toward the translucent portion is used. In the inner-layer lens of Comparative Example 2, the surface facing the translucent portion was formed only by the first portion 51a, and the second portion 51b is not provided. In Example 1, an analysis model having the configuration of the optical module 1 described in the present example embodiment is used. In Comparative Example 1 and Comparative Example 2, only the configurations of the inner-layer lens are different, and the other configurations are the same as those in Example 1.

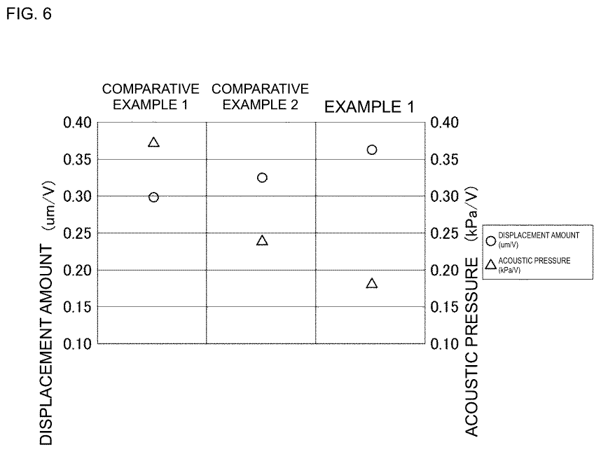

FIG. 6 is a graph showing an example of the simulation result of the displacement amount and the acoustic pressure of the translucent portion in Comparative Example 1, Comparative Example 2, and Example 1. The acoustic pressure shown in FIG. 6 indicates the acoustic pressure in the gap G0, and the displacement amount indicates the displacement amount of the central portion of the translucent portion 10.

As shown in FIG. 6, in Example 1, the acoustic pressure in the gap G0 is small, and the displacement amount of the translucent portion 10 is large, as compared with Comparative Example 1 and Comparative Example 2. In Example 1, the first portion 51a of the inner-layer lens 51 protrudes toward the translucent portion 10 and defines a surface having a curvature. Therefore, the acoustic wave reflected by the first portion 51a is likely to be diffused.

The second portion 51b that is disposed in the direction separated farther from the translucent portion 10 than the first portion 51a is provided at the outer periphery of the first portion 51a. Therefore, the second gap G2 between the second portion 51b and the translucent portion 10 is larger than the first gap G1 between the first portion 51a and the translucent portion 10 at the outer periphery of the first portion 51a. Therefore, the acoustic wave in the gap G0 is likely to be emitted toward the outer side portion of the inner-layer lens 51 in a radial direction.

On the other hand, in Comparative Example 1, since the surface of the inner-layer lens facing the translucent portion 10 is formed to be flat, the acoustic wave reflected by the inner-layer lens is less likely to be diffused. In addition, since the gap is reduced from the center of the translucent portion toward the outer side portion in the radial direction, the acoustic wave in the gap is less likely to be emitted to the outer side portion of the inner-layer lens in the radial direction.

Comparative Example 2 is different from Comparative Example 1 in that the surface of the inner-layer lens facing the translucent portion 10 protrudes toward the translucent portion 10 and includes a curvature, and thus the acoustic wave reflected by the inner-layer lens is likely to be diffused. However, Comparative Example 2 is similar to Comparative Example 1 in that the gap is reduced from the center of the translucent portion toward the outer side portion in the radial direction, and thus the acoustic wave in the gap is less likely to be emitted to the outer side portion of the inner-layer lens in the radial direction.

As described above, in Example 1, as compared with Comparative Example 1 and Comparative Example 2, the configuration in which the acoustic wave is likely to be emitted from the gap G0 has been made, and thus it is possible to reduce the acoustic wave in the gap G0. As a result, it is possible to reduce or prevent the vibration attenuation and increase the displacement amount of the translucent portion 10.

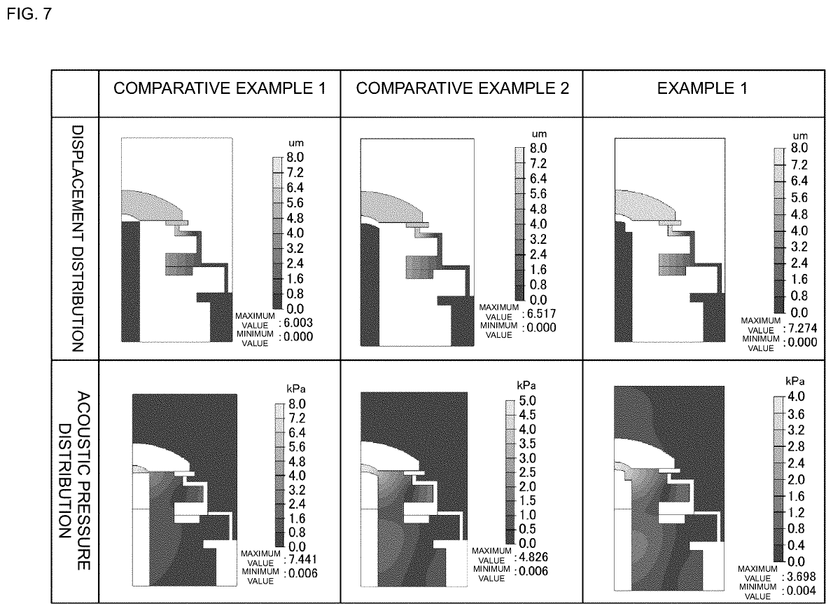

FIG. 7 is a view showing an example of a displacement distribution and an acoustic pressure distribution in Comparative Example 1, Comparative Example 2, and Example 1. As shown in FIG. 7, the maximum displacement amount of the translucent portion is about 6 μm in Comparative Example 1, the maximum displacement amount is about 6.5 μm in Comparative Example 2, and the maximum displacement amount is about 7.2 μm in Example 1.

On the other hand, in a case of focusing on the acoustic pressure distribution, it can be seen that the acoustic wave is emitted to the outer side portion of the inner-layer lens 51 in the radial direction in Example 1 as compared with Comparative Example 1 and Comparative Example 2. That is, it can be seen that the concentration of the acoustic wave in the gap G0 is suppressed in Example 1, as compared with Comparative Example 1 and Comparative Example 2.

### Regarding Dimension of Second Gap

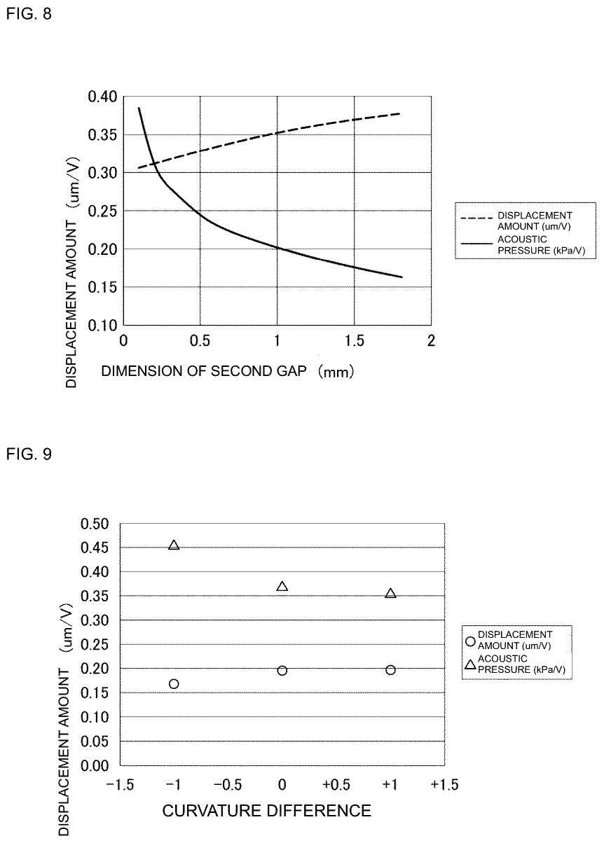

FIG. 8 is a graph showing an example of a relationship between the dimension of the second gap G2 and the displacement amount of the translucent portion. As shown in FIG. 8, the larger the dimension of the second gap G2 is, the larger the displacement amount of the translucent portion 10 is. In the present example embodiment, the dimension of the first gap G1 is about 50 μm, for example. The dimension of the second gap G2 is preferably larger than about 50 μm, for example. More preferably, the dimension of the second gap G2 is about 60 μm or more, for example.

Alternatively, the dimension of the second gap G2 is preferably about 1.2 times or more the dimension of the first gap G1, for example. More preferably, the dimension of the second gap G2 is about 1.5 times or more the dimension of the first gap G1, for example.

### Regarding Relationship Between Curvature of Recess of Translucent Portion and Curvature of First Portion of Inner-Layer Lens

A relationship between the curvature of the recess 11 of the translucent portion 10 and the curvature of the first portion 51a of the inner-layer lens 51 will be described with reference to FIG. 9.

FIG. 9 is a graph showing an example of the relationship between the curvature of the recess 11 of the translucent portion 10 and the curvature of the first portion 51a of the inner-layer lens 51. In FIG. 9, the horizontal axis indicates a difference in curvature, and the vertical axis indicates the displacement amount of the translucent portion 10. The “difference in curvature” means a value obtained by subtracting the curvature of the first portion 51a from the curvature of the recess 11.

In FIG. 9, when the difference in curvature is “−1”, the curvature of the first portion 51a is larger than the curvature of the recess 11. When the difference in curvature is “0”, the curvature of the recess 11 and the curvature of the first portion 51a are equal to each other. When the difference in the curvature is “+1”, the curvature of the first portion 51a is smaller than the curvature of the recess 11.

As shown in FIG. 9, when the difference in curvature is “−1”, the acoustic pressure is lower and the displacement amount of the translucent portion 10 is larger than the acoustic pressure and the displacement amount when the difference in curvature is “0” and “+1”. That is, as the curvature of the first portion 51a becomes larger than the curvature of the recess 11, the acoustic pressure is lowered and the displacement amount is increased.

From this, it is preferable that the curvature of the recess 11 of the translucent portion 10 is smaller than the curvature of the first portion 51a of the inner-layer lens 51. As a result, it is possible to reduce the acoustic pressure in the gap G0 and reduce or prevent the vibration attenuation. As a result, it is possible to increase the displacement amount of the translucent portion 10.

### Advantageous Effects

According to the optical module 1 and the optical device 100 according to Example Embodiment 1, it is possible to exhibit the following effects.

The optical module 1 includes the translucent portion 10, the vibrator 20, the piezoelectric element 30, and the inner-layer optical component 50. The vibrator 20 preferably has a tubular shape and supports the translucent portion 10. The piezoelectric element 30 is disposed at the vibrator 20 and vibrates the vibrator 20.

The inner-layer optical component 50 is disposed at the inner side portion of the vibrator 20. The recess 11 that is recessed in the thickness direction (Z-direction) of the translucent portion 10 and includes a curvature is located at the surface PS2 of the translucent portion 10 facing the inner-layer optical component 50. The inner-layer optical component 50 includes the inner-layer lens 51 that faces the translucent portion 10. The inner-layer lens 51 includes the first portion 51a that protrudes toward the translucent portion 10 and includes a curvature, and the second portion 51b that is provided at the outer periphery of the first portion 51a. The first gap G1 is located between the first portion 51a and the translucent portion 10 at the outer periphery of the first portion 51a. The second gap G2 is located between the second portion 51b and the translucent portion 10. The second gap G2 is larger than the first gap G1.

With such a configuration, it is possible to reduce or prevent the vibration attenuation. According to the optical module 1, it is possible to reduce or prevent the concentration of the acoustic pressure in the gap G0 located between the translucent portion 10 and the inner-layer lens 51. Specifically, in the inner-layer lens 51, the second gap G2 is made larger than the first gap G1, so that the acoustic wave reflected in the gap G0 is likely to be emitted to the outer side portion of the inner-layer lens 51. As a result, it is possible to reduce the acoustic pressure in the gap G0, and reduce or prevent the vibration attenuation of the translucent portion 10. As a result, it is possible to increase the displacement amount of the translucent portion 10 and improve the removal efficiency of liquid droplets adhering to the translucent portion 10.

The second portion 51b is a step that is recessed in the direction separated farther from the translucent portion 10 than the first portion 51a. With such a configuration, it is possible to make the second gap G2 larger than the first gap G1, and reduce or prevent the vibration attenuation of the translucent portion 10.

A size of the second gap G2 is about 1.2 times or more than that of the first gap G1, for example. With such a configuration, it is possible to further reduce or prevent the vibration attenuation of the translucent portion 10.

When viewed from the thickness direction (Z-direction) of the translucent portion 10, the outer diameter D22 of the inner-layer lens 51 is larger than the outer diameter D12 of the recess 11 of the translucent portion 10. With such a configuration, it is possible to reduce or prevent the vibration attenuation of the translucent portion 10 while improving the optical characteristics.

The curvature of the first portion 51a of the inner-layer lens 51 is larger than the curvature of the recess 11 of the translucent portion 10. With such a configuration, the acoustic wave reflected by the first portion 51a is more likely to be diffused. As a result, it is possible to further reduce or prevent the concentration of the acoustic pressure in the gap G0 and further reduce or prevent the vibration attenuation.

The second portion 51b includes the flat surface FS1 perpendicular to the thickness direction (Z-direction) of the inner-layer lens 51. The inner-layer optical component 50 includes the tubular lens holding portion 52 that accommodates the inner-layer lens 51. The lens holding portion 52 includes the pressing portion 52a that is in contact with the flat surface FS1 at the inner side portion of the lens holding portion 52. With such a configuration, it is possible to stably hold the inner-layer lens 51 by the pressing portion 52a of the lens holding portion 52 while reducing or preventing the concentration of the acoustic pressure by the second portion 51b.

As a result, it is possible to reduce or prevent falling off of the inner-layer lens 51, and reduce or prevent the misalignment, and thus it is possible to maintain the optical path.

The inner-layer lens 51 is configured by a spherical lens or an aspherical lens. With such a configuration, the inner-layer lens 51 including the first portion 51a and the second portion 51b can be easily manufactured.

The recess 11 of the translucent portion 10 has a shape that is recessed in a hemispherical shape. With such a configuration, it is possible to diffuse the acoustic wave when the acoustic wave is reflected even in the recess 11 of the translucent portion 10. As a result, it is possible to reduce or prevent the concentration of the acoustic pressure in the gap G0 and reduce or prevent the vibration attenuation.

The optical device 100 includes the optical module 1 and the optical element 2 disposed at the optical module 1. With such a configuration, it is possible to exhibit the similar effects to the effects of the optical module 1 described above.

### Modification Example 1

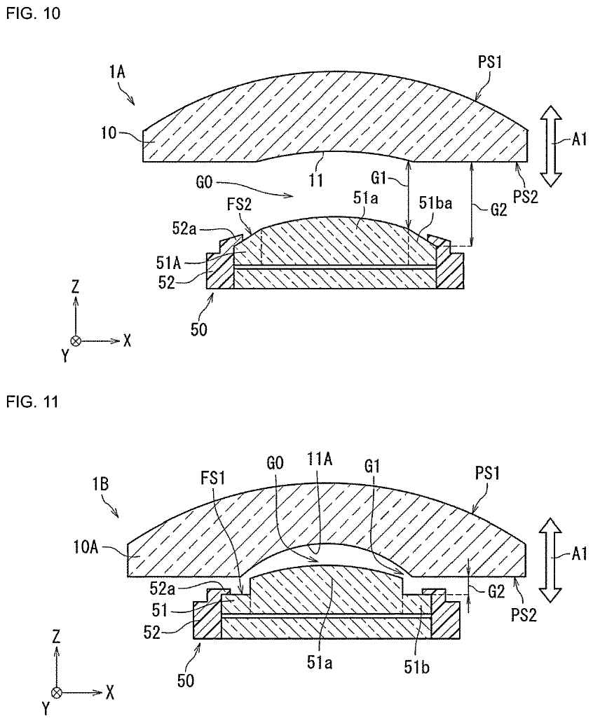

FIG. 10 is a schematic cross-sectional view showing a main configuration of an optical module 1A in Modification Example 1. As shown in FIG. 10, a second portion 51ba of an inner-layer lens 51A may include an inclination surface FS2 that is inclined in the direction extending away from the translucent portion 10 toward the outer periphery of the inner-layer lens 51A. The inclination surface FS2 is inclined such that the second gap G2 continuously increases toward the outer side portion of the inner-layer lens 51A in the radial direction. The inner-layer lens 51A may be configured by, for example, an aspherical lens.

Also in such a configuration, since the second gap G2 can be made larger than the first gap G1, it is possible to reduce or prevent the concentration of the acoustic pressure in the gap G0 and reduce or prevent the vibration attenuation of the translucent portion 10.

### Modification Example 2

FIG. 11 is a schematic cross-sectional view showing a main configuration of an optical module 1B in Modification Example 2. As shown in FIG. 11, the first portion 51a of the inner-layer lens 51 may be disposed in a recess 11A of a translucent portion 10A. The curvature of the recess 11A may be larger than the curvature of the first portion 51a of the inner-layer lens 51.

With such a configuration, it is possible to reduce the size of the optical module 1 by disposing the translucent portion 10 and the inner-layer lens 51 closer to each other. As described above, a configuration in which, even though the translucent portion 10 and the inner-layer lens 51 are disposed close to each other to reduce the gap G0, the second gap G2 is made larger than the first gap G1, whereby the acoustic wave is likely to be emitted from the gap G0 has been made. As a result, it is possible to reduce or prevent the concentration of the acoustic pressure in the gap G0 and reduce or prevent the vibration attenuation of the translucent portion 10 while realizing the reduction in size of the optical module 1B.

### Modification Example 3

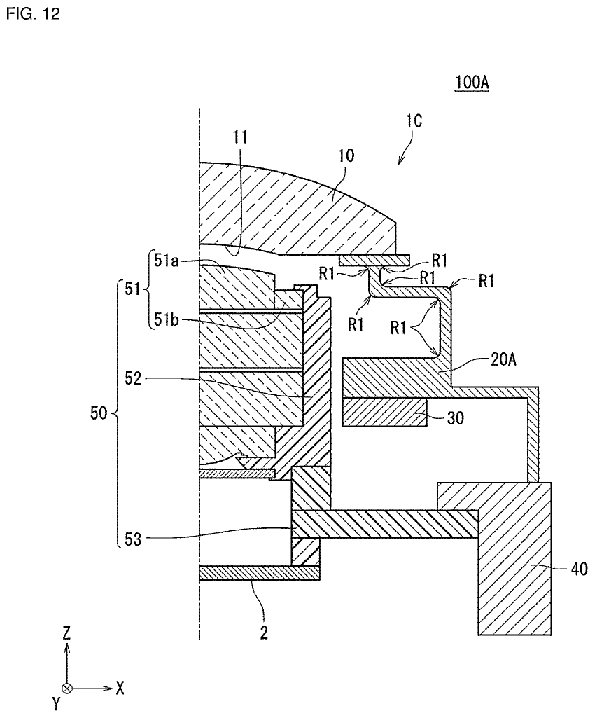

FIG. 12 is a schematic cross-sectional view showing a main configuration of an optical device 100A in Modification Example 3. As shown in FIG. 12, in an optical module 1C of the optical device 100A, a curved portion R1 is provided at the corner portion of a vibrator 20A. The curved portion R1 is provided in a portion to which each of components of the vibrator 20A is connected. The curved portion R1 has a rounded and curved shape.

By providing the curved portion R1 at the corner portion of the vibrator 20A, it is possible to disperse the stress at the time of the vibration of the vibrator 20A. As a result, it is possible to reduce the stress, so that it is possible to reduce or prevent fatigue fracture of the vibrator 20A and improve the reliability.

In the present example embodiment, the example in which the second portion 51b is configured by the step or the inclination surface has been described, but the present disclosure is not limited thereto. The second portion 51b at least is preferably structured such that the second gap G2 is larger than the first gap G1. For example, the second portion 51b may be configured by a curved surface that is curved in the direction extending away from the translucent portion 10. The curved surface is, for example, a surface including a curvature.

The present invention has been described in sufficient detail in relation to the example embodiments with reference to the accompanying drawings, but various modifications and changes can be made. It should be understood that such a modification or change is included in example embodiments of the present invention as long as it does not depart from the scope of the present invention according to the accompanying claims.

The vibration devices and vibration control methods according to the example embodiments of the present invention can be applied to an in-vehicle camera, a surveillance camera, an optical sensor such as LiDAR, or the like used outdoors.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An optical module comprising:
a translucent portion;
a vibrator with a tubular shape and supporting the translucent portion;
a piezoelectric element located at the vibrator to vibrate the vibrator; and
an inner-layer optical component located at an inner side portion of the vibrator; wherein
a recess that is recessed in a thickness direction of the translucent portion and includes a curvature at a surface of the translucent portion facing the inner-layer optical component;
the inner-layer optical component includes an inner-layer lens that faces the translucent portion;
the inner-layer lens includes a first portion that protrudes toward the translucent portion and includes a curvature and a second portion at an outer periphery of the first portion;
a first gap is located between the first portion and the translucent portion in the outer periphery of the first portion;
a second gap is located between the second portion and the translucent portion; and
the second gap is larger than the first gap.

2. The optical module according to claim 1, wherein the second portion includes a step that is recessed in a direction separated farther from the translucent portion than the first portion.

3. The optical module according to claim 1, wherein the second portion includes an inclination surface that is inclined in a direction extending away from the translucent portion toward an outer periphery of the inner-layer lens.

4. The optical module according to claim 1, wherein a size of the second gap is about 1.2 times or more than the first gap.

5. The optical module according to claim 1, wherein when viewed from the thickness direction of the translucent portion, an outer diameter of the inner-layer lens is larger than an outer diameter of the recess of the translucent portion.

6. The optical module according to claim 1, wherein the curvature of the first portion of the inner-layer lens is larger than the curvature of the recess of the translucent portion.

7. The optical module according to claim 1, wherein
the second portion includes a flat surface perpendicular to a thickness direction of the inner-layer lens;
the inner-layer optical component includes a lens holding portion that has a tubular shape and accommodates the inner-layer lens; and
the lens holding portion includes a pressing portion that is in contact with the flat surface at an inner side portion of the lens holding portion.

8. The optical module according to claim 1, wherein the first portion is in the recess of the translucent portion.

9. The optical module according to claim 1, wherein the inner-layer lens is a spherical lens or an aspherical lens.

10. The optical module according to claim 1, wherein the recess of the translucent portion is recessed in a hemispherical or substantially hemispherical shape.

11. An optical device comprising:
the optical module according to claim 1; and
an optical element at the optical module.

12. The optical device according to claim 11, wherein the second portion includes a step that is recessed in a direction separated farther from the translucent portion than the first portion.

13. The optical device according to claim 11, wherein the second portion includes an inclination surface that is inclined in a direction extending away from the translucent portion toward an outer periphery of the inner-layer lens.

14. The optical device according to claim 11, wherein a size of the second gap is about 1.2 times or more than the first gap.

15. The optical device according to claim 11, wherein when viewed from the thickness direction of the translucent portion, an outer diameter of the inner-layer lens is larger than an outer diameter of the recess of the translucent portion.

16. The optical device according to claim 11, wherein the curvature of the first portion of the inner-layer lens is larger than the curvature of the recess of the translucent portion.

17. The optical device according to claim 11, wherein
the second portion includes a flat surface perpendicular to a thickness direction of the inner-layer lens;
the inner-layer optical component includes a lens holding portion that has a tubular shape and accommodates the inner-layer lens; and
the lens holding portion includes a pressing portion that is in contact with the flat surface at an inner side portion of the lens holding portion.

18. The optical device according to claim 11, wherein the first portion is in the recess of the translucent portion.

19. The optical device according to claim 11, wherein the inner-layer lens is a spherical lens or an aspherical lens.

20. The optical device according to claim 11, wherein the recess of the translucent portion is recessed in a hemispherical or substantially hemispherical shape.
